(19) United States
(12) Patent Application Publication
(10) Pub. No.: US 2008/0212110 A1
(43) Pub. Date: Sep. 4, 2008

(54) PDF DIRECT PRINTING METHOD UTILIZING PAGE PRINTING ORDER INFORMATION FOR EFFICIENT HANDLING OF DATA

(75) Inventor: Duc Phu Truong, West Covina, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 11/691,848

(22) Filed: Mar. 27, 2007

Related U.S. Application Data
(63) Continuation-in-part of application No. 11/681,138, filed on Mar. 1, 2007.
Application No. 11/681,138 is a continuation-in-part of application No. 11/690,648, filed on Mar. 23, 2007.

(51) Int. Cl. G06F 3/12

(52) U.S. Cl. 358/1.6

(57) ABSTRACT

In a PDF direct printing method, a client computer transfers PDF direct print data to a printer controller for direct printing. The client is provided with page printing order information which specifies which pages of the PDF file are to be printed, and preferably also the order in which the pages are to be printed. Based on this information, a PDF parser on the client parsers out the PDF data and transfers to the printer controller only the pages of data as specified by the page printing order. The page printing order information is either transmitted to the client from the printer controller, or supplied by a program on the client that initiated the PDF direct printing process. The printer controller stores the PDF direct print data transferred from the client, and maintains a memory allocation database to record the memory locations where pieces of the PDF data are stored.

This application is a continuation-in-part of U.S. application Ser. No. 11/681138, filed Mar. 1, 2007, now pending, which is herein incorporated by reference in its entirety, and a continuation-in-part of U.S. application Ser. No. 11/690648, filed Mar. 23, 2007, now pending, which is herein incorporated by reference in its entirety.

### BACKGROUND OF THE INVENTION

1. Field of the Invention

This invention relates to direct printing of a file of a certain description language, such as a PDF file, and in particular, it relates to a PDF direct printing method and apparatus that utilize the page printing order information for efficient handling of the PDF data.

2. Description of Related Art

A PDF (Portable Document Format) file contains a plurality of blocks of data (objects) which are either commands or resources. At the end of a PDF file is a cross-reference table (also referred to as the directory information) that lists all of the resources and commands contained in the PDF file, specifying for each of them an offset value from the beginning of the PDF file which represents the location of the resource or command within the PDF file. When a command needs to use a resource, it refers to the cross-reference table to determine the location of the resource within the file. A resource may be referenced many times by different commands. A PDF file may logically contain a plurality of pages of data, each page including a plurality of blocks of data, but unlike in some other page description languages, data in a PDF file is physically organized in a random fashion rather than a linear fashion (i.e., no particular order is required).

PDF direct printing is a process by which a PDF file is sent directly by a client computer to a compatible printer device without first using an application or print driver to pre-process the PDF data into a traditional print language such as PDL (Page Description Language). PDF direct printing has the advantage of improved speed and/or quality of output. In a conventional PDF direct printing process, the client computer transfers the entire PDF file sequentially to the printer controller (which may reside either on a server connected to a printer, or on the printer as embedded controller). FIG. 1 illustrates a timing sequence for data transfer from the client computer to the printer controller according to conventional PDF direct printing methods. As shown in FIG. 1, the resources for page 1 through page N (N being the total number of pages in the PDF file) are transferred in that order, and then drawing commands for page 1 through page N are transferred in that order. In this example, the transfer order of the blocks of data is determined by the order in which the data is organized in the PDF file. Because of its location within the PDF file, the directory information block is transferred after the commands and resources blocks. The printer controller saves the PDF data on a hard disk as a PDF file which is identical to the PDF file residing on the client computer. When rendering the PDF data, the printer controller reads the PDF data from the disk in a non-sequential manner (i.e., it reads the blocks of PDF data according to the order in which the blocks are needed for the rendering process, not according to the sequence in which the blocks are stored in the PDF file), and processes the PDF data to generate raster image data.

Various alternative methods have been described for PDF direct printing. For example, U.S. Patent Publication 2004/0098410 describes a method in which the client extracts the cross-reference table (i.e. the directory information block) and the trailer portion of the PDF file, which is typically located at the end of the file, and transmits them to the printer first. Then, the printer analyzes the information in the cross-reference table and the trailer, and generates requests to the client regarding which part of the PDF file it needs next. In response thereto, the client transmits the requested part of the PDF file to the printer.

### SUMMARY

Accordingly, the present invention is directed to a method and apparatus for direct printing of PDF or other file that substantially obviates one or more of the problems due to limitations and disadvantages of the related art.

An object of the present invention is to reduce time required for transferring the PDF data.

Another object of the present invention is to prevent unnecessary storage of unused PDF data on the printer controller.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for transferring data of a file from a client computer to a printer controller connected to the client computer for direct printing, the file including a plurality of pages of data, the method including: on the client computer, (a) obtaining information regarding a page printing order, the information specifying which pages of the file are to be printed; and (b) selectively transferring to the printer controller only pages of data within the page printing order. The method further includes, on the printer controller, (c) obtaining the information regarding the page printing order; (d) transmitting the information regarding the page printing order to the client computer; (e) receiving pages of data from the client; and (f) storing the received pages of data.

In another aspect, the present invention provides a computer program product comprising a computer usable medium having a computer readable code embodied therein for controlling a data processing system including a client computer and a printer controller connected thereto, the computer readable program code comprising code configured to cause the client computer to execute a client process for transferring data of a file from the client computer to the printer controller for direct printing, the client process including the steps of: (a) obtaining information regarding a page printing order, the information indicating pages of the file to be printed; and (b) selectively transferring to the printer controller only pages of data within the page printing order.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a data transfer timing sequence in a conventional PDF direct printing method.

FIG. 2 schematically illustrates a data transfer timing sequence in a PDF direct printing method according to an embodiment of the present invention.

FIG. 3 schematically illustrates a client and printer system in which methods according to embodiments of the present invention may be implemented.

FIG. 4 illustrates a PDF data transferring process executed by the client computer according to embodiments of the present invention.

FIG. 5 illustrates a data storing process executed by the printer controller according to embodiments of the present invention.

FIG. 6 illustrates a PDF data parsing and transferring process executed by the client computer according to an alternative embodiment of the present invention.

FIG. 7 illustrates a data storing process executed by the printer controller according to the alternative embodiment of the present invention.

FIG. 8 illustrates a rendering process executed by the PDF rendering module of the printer controller according to the alternative embodiment of the present invention.

FIG. 9 illustrates a PDF data parsing and transferring process executed by the client computer according to another alternative embodiment of the present invention.

FIG. 10 illustrates a data storing process executed by the printer controller according to the other alternative embodiment of the present invention.

FIG. 11 illustrates a rendering process executed by the PDF rendering module of the printer controller according to the other alternative embodiment of the present invention.

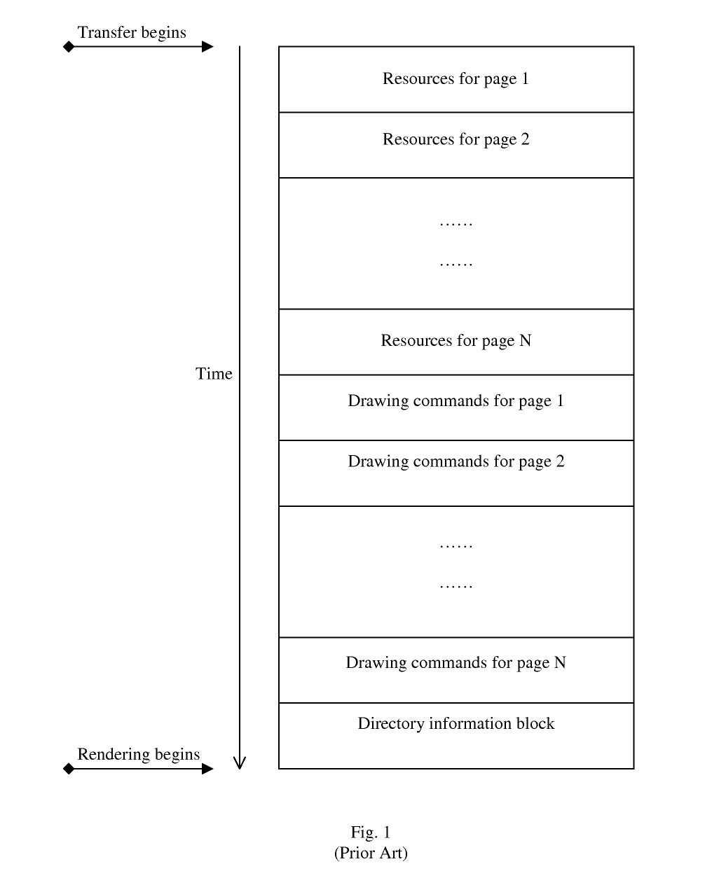

### DETAILED DESCRIPTION OF PREFERRED EMBODIMENTS

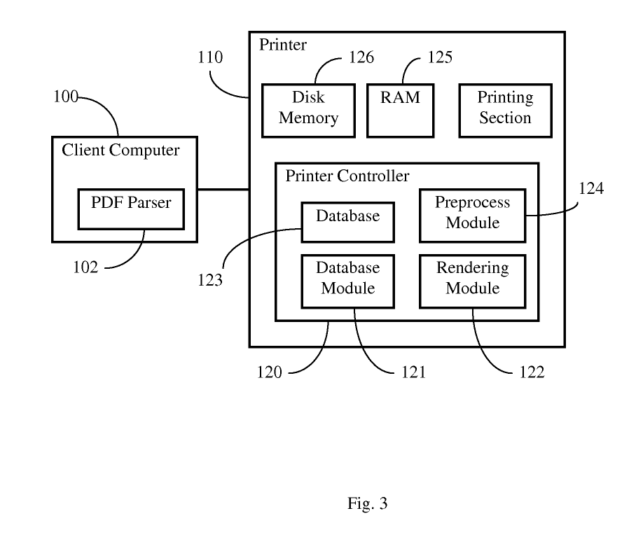

FIG. 3 schematically illustrates a system including a client computer 100 connected to a printer 110 on which methods according to embodiments of the present invention may be implemented. The client computer and the printer may be connected by a network or a direct connection cable. The client computer 100 includes a PDF parser 102 and the printer 110 includes a printer controller 120. In this embodiment each of the PDF parser 102 and the printer controller 120 is fully or partly implemented by a central processing unit (CPU) of the client computer 100 or the printer 110 executing a computer program stored in a storage device such as a read only memory (ROM) and a hard disk. Although in this figure the printer controller 120 is shown as residing on the printer 110, it may also reside on a server connected to the client computer and the printer (not shown). The RAM 125 and the hard disk 126 are resources associated with the printer controller. The printer controller 120 includes a preprocessor module 124 that manages print jobs, including performing the functions of spooling PDF direct print data from the client and storing the data on the RAM 124 or the disk 125. The printer controller may also include a database module 121 that maintains a memory allocation database 123 as will be described in more detail later. Note that although the preprocessor module 124 and the database module 121 are shown in FIG. 3 as two separate modules, the functions of the database module may be performed by the preprocessor module. A rendering module 122 of the printer controller interprets the PDF direct print data and performs other image rendering functions.

The client computer 100 and the printer controller 120 cooperate with each other to perform a PDF direct printing process, by which the client computer 100 transfers PDF direct print data from a PDF file residing on the client computer to the printer controller 120, the printer controller stores the PDF direct print data in one or more memory devices of the printer controller (disk and/or RAM), and the rendering module 122 of the printer controller renders raster images from the PDF direct print data stored on the printer controller.

Embodiments of the present invention provide various methods that take advantage of the page printing order information during a PDF direct printing process. Page printing order refers to the order in which pages of a PDF document (either all or some of the pages) are to be rendered and printed by a particular print job. One example of a print job whose page printing order is different from the page order of the file is the case of a booklet print job. If a print job requires pages 1 to 4 to be printed in booklet mode, the printing order of page 1, page 4, page 2, and page 3 would yield better printing performance than the normal printing order 1, 2, 3 and 4because in booklet mode page 1 and page 4 would be imaged together onto one sheet of paper and page 2 and 3 would be imaged together onto a separate sheet of paper. In other situations, the print job may require some but not all of the pages of a file to be printed. In a weaker form, the page printing order specifies which pages of the file are to be printed but does not specify the order in which they are printed. If the PDF direct printing process is initiated by the client computer 100, the page printing order may be provided by the program that initiated the PDF direct printing. If the PDF direct printing process is initiated by the printer controller 120, the printer controller will transmit the page printing order information to the client computer 100 before (and possibly also during) PDF data transfer from the client computer to the printer controller. According to embodiments of the present invention, the PDF parser 102 on the client computer parses the PDF file and selectively transfers PDF direct print data to the printer controller based on the page printing order information, so that only pages of PDF data within the page printing order is transferred to the printer controller and PDF data outside of the page printing order is not transferred. Here, “PDF data within the page printing order” means PDF data, including commands and resources, that will be required for rendering the pages to be printed. “PDF data outside of the page printing order” means PDF data that will not be required for rendering the pages to be printed. By transferring only the PDF data within the page printing order, traffic on the network connecting the client and the printer controller is reduced and time required for transferring the PDF data is reduced. In addition, it prevents unnecessary storage of unused PDF data on the printer controller.

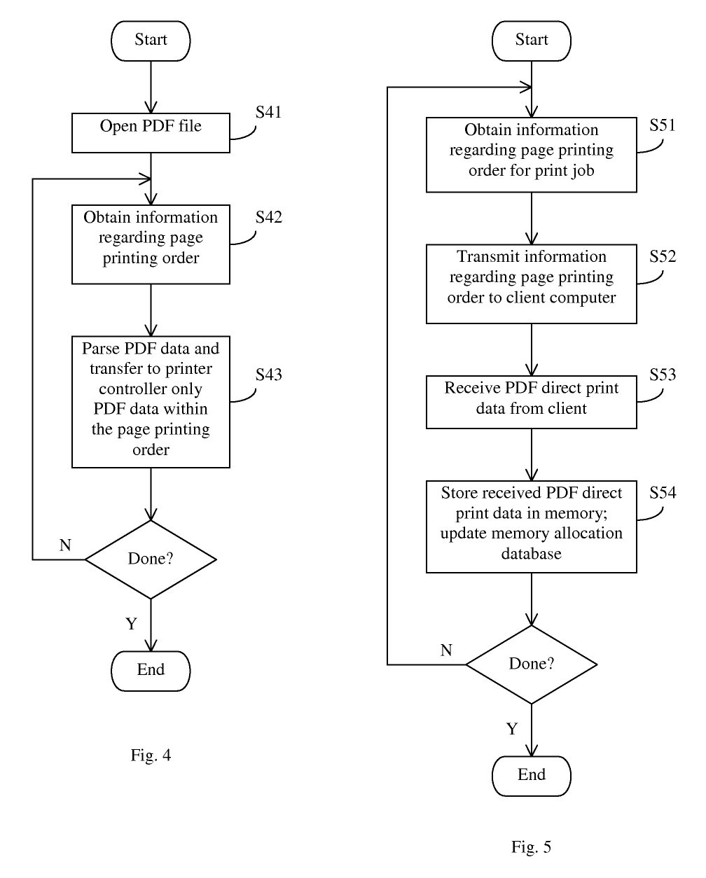

FIG. 4 illustrates a PDF direct print data transfer method performed by the PDF parser 102 according to an embodiment of the present invention. After the PDF direct printing is initiated, either by the client computer 100 or the printed controller 120, the PDF parser 102 opens the PDF file (step S41), and obtains information regarding the page printing order (step S42). As mentioned earlier, the page printing order may be provided by the client computer 100 itself or by the printer controller 120. The PDF parser 102 then parses PDF data from the PDF file using the page printing order information, and transfers to the printer controller only the PDF data within the page printing order (step S43). Sometimes, the program that initiated the PDF direct printing process may not have the full page printing order information for the entire print job at the beginning the PDF direct printing process. In such a case, the information obtained in step S42 will partially specify the page printing order, for example, the first few pages to be printed, and the program that initiated the PDF direct printing will continue to make additional page printing order information available to the parser 102. Thus, the parser will obtain additional page printing order information (step S42) and continue to transfer the PDF data using the additional page printing order information (step S43).

FIG. 5 illustrates a process performed by the printer controller 120 that spools PDF direct print data from the client computer 100 during a PDF direct printing process. At the beginning of the PDF direct printing process, the preprocessor module 124 obtains page printing order information for the print job (step S51). For example, the preprocessor module may examine the job ticket (a job ticket is a set of parameters associated with a print job that govern the printing of a document) to obtain the page printing order information. The preprocessor module transmits the page printing order information to the client computer 100 (step S52). In response, the client computer performs the PDF data transfer process illustrated in FIG. 4. The printer controller receives the PDF direct print data from the client (step S53), and stores the PDF data in memory (the RAM or the disk). Because the PDF data is often not in the order as they are arranged in the original PDF file, the database module 121 records the memory location where each piece of PDF data is stored in the memory allocation database 123 (step S53). The memory allocation database will be used by the rendering module 122 during the subsequent rendering process to retrieve the PDF data. If at the beginning of the PDF direct printing process the preprocessor module did not have the complete page printing order information, i.e., the information obtained and transmitted to the client in steps S51 and S52 are partial page printing order information, then the preprocessor module will continue to obtain additional page printing order information and transmit it to the client until the entire print job is completed.

While a common feature of all embodiments of the present invention is the selective transfer of only PDF data within the page printing order, the client parser 102 may implement various data transfer schemes with various levels of sophistication. In a first alternative embodiment, the client parser 102 transfers only PDF direct print data within the page printer order, and transfers the pages in the order as they occur in the PDF file. For example, if the page printing order specifies that pages 5-10 and 3 are to be printed in that order, but the PDF data for page 3 occurs earlier in the PDF file than the data for pages 5-10, the parser 102 will transfer the PDF data for page 3 before the data for pages 5-10. In a second alternative embodiment, the client parser 102 transfers pages of PDF data in the order as specified in the page printing order. Thus, in the above example, the client parser 102 will transfer the PDF data for pages 5-10 before the data for page 3, even though the data for page 3 occurs earlier in the PDF file. In a third alternative embodiment, the client parser 102 transfers blocks of PDF data according to the order in which the blocks will be used by the rendering module 122 of the printer controller to render the images. Preferably, in the second and third alternative embodiments, the client parser 102 transfers the directory information block before any blocks of PDF data is transferred. Having received the directory information block, the rendering module 122 of the printer controller will be able to start the rendering process as soon as sufficient PDF data (e.g., the first page or first block of PDF data) is received, instead of having to wait for all PDF data to be received from the client computer. This reduces the delay in the time for the first page to be printed (“first page out time”, or FPOT).

In a fourth alternative embodiment, the client parser 102 transfers blocks of PDF data in the same way as in the third alternative embodiment, and adds metadata to each block of PDF data transferred. An additional advantage of the fourth embodiment is that it enables the printer controller 120 to efficiently handle the received PDF data. For example, the printer controller 120 may use the metadata to decide whether the blocks of PDF data will be stored in the RAM 125 or the disk 126 of the printer controller.

An exemplary PDF direct print data transfer method according the third embodiment is described in more detail below. This embodiment has been fully disclosed in the parent application, U.S. application Ser. No. 11/681138.

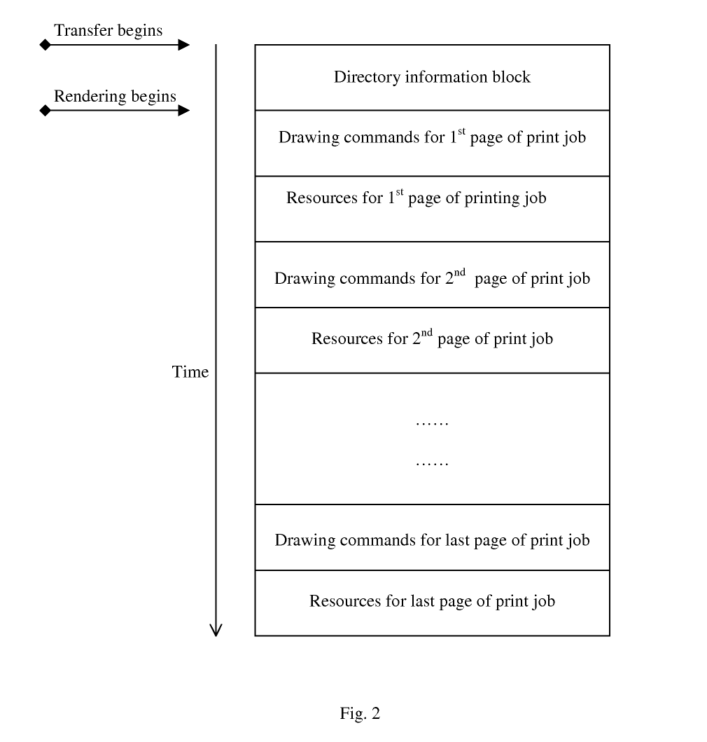

FIG. 2 illustrates a timing sequence for data transfer of a PDF direct printing method according to this alternative embodiment. As shown in FIG. 2, the directory information block of the PDF file is transferred from the client first. The drawing commands and the resources for the first page of the PDF file to be printed is then transferred, followed by the drawing commands and the resources for the second page of the PDF file to be printed, etc. The PDF rendering process begins some time soon after the directory information block has been transferred, which is typically before all the data for the first page is transferred.

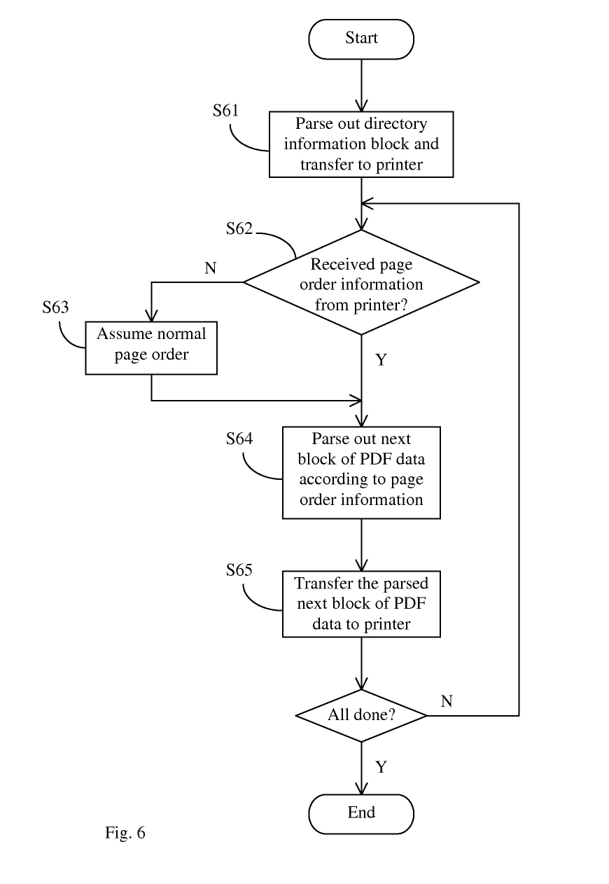

FIG. 6 illustrates a PDF data parsing and transferring process executed by the PDF parser 102 according to the third alternative embodiment. After the PDF direct printing is initiated, the parser first parses out the directory information block from the PDF file and transfers it to the printer 100 (step S61). The parser continuously monitors any information received from the printer, including page printing order information, or any other information that may affect the desired sequence of transfer of the PDF direct print data. One example of such information is an “abort page” command. If no specific page order information has been received from the printer, the parser assumes a normal page order (i.e. to print from the first page to the last page) (steps S62 and S63). Based on the page order information (either specific page order information received from the printer, or a normal page order), the parser then parses out the next block of PDF data that will be needed by a rendering process (step S64) and transfers it to the printer controller (step S65). The parsing algorithm may be implemented using any suitable PDF parsing library with suitable modifications. This process (steps S62 to S65) is repeated until the entire print job is processed, i.e., all pages of the PDF file specified by the page printing order are transferred to the printer.

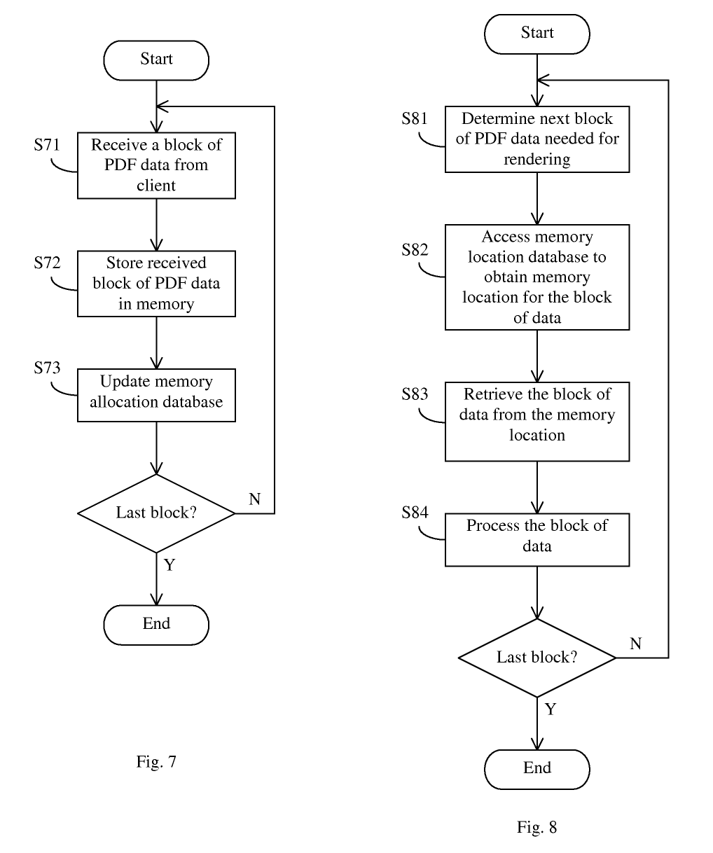

The blocks of PDF data transferred by the client parser 102 is received and utilized by the printer controller in a process shown in FIGS. 7 and 8. FIG. 7 illustrates a data storing process executed by the database module 121 of the printer controller 120. After receiving a block of PDF data from the client (step S71), the database module stores the received block of data in the memory (RAM 125 or disk 126) (step S72) and updates the memory allocation database 123 by recording the memory location where the block of data is stored (step S73). This process (steps S71 to S73) is repeated until all pages of the PDF file to be printed have been received. Although not illustrated in this figure, when appropriate, the rendering module transmits page order information to the parser 102 as described earlier. FIG. 8 illustrates a rendering process executed by the PDF rendering module 122 of the printer controller 120. After the rendering process is initiated (as pointed out earlier, the rendering process can start as soon as some PDF data is received from the client and before all PDF data is received), the rendering module determines the next block of PDF data it needs for rendering (step S81). The directory information block (which has already been transferred to the printer) may be referred to in making this determination. The rendering module then accesses the memory allocation database 123 to obtain the memory location of the needed block of PDF data (step S82). Because of the use of the intelligent PDF parser 102 on the client, the needed block of data has already been transferred to the printer and stored in the memory 125/126 by the database module 121. After obtaining the memory location, the rendering module retrieves the needed block of data from the memory 125/126 (step S83). The rendering module then processes the block of data retrieved from the memory to render a raster image (step S84). This process (steps S81 to S84) is repeated until all pages of the PDF file to be printed has been rendered.

An exemplary PDF direct print data transfer method according the fourth alternative embodiment is described in more detail below. This alternative embodiment has been fully disclosed in the parent application, U.S. application Ser. No. 11/690648. In this alternative embodiment, the printer controller stores all or part of the PDF direct print data in a reserved RAM 125, rather than in the disk 126 as in conventional PDF direct printing methods. Storing as much PDF direct print data on RAM increases the rendering speed because RAM access is much faster than disk access. When space in the RAM is insufficient to store all the PDF data for a print job, the preprocessor module implements a PDF data splitting algorithm to determine which pieces of the PDF data are stored on RAM and which pieces are stored on disk. Generally speaking, PDF data that is used earlier in the rendering process is stored on RAM until the RAM is full. The PDF data may also be stored on RAM based on their frequency of use. Various alternative PDF data splitting algorithms are described more fully in the above-identified parent application.

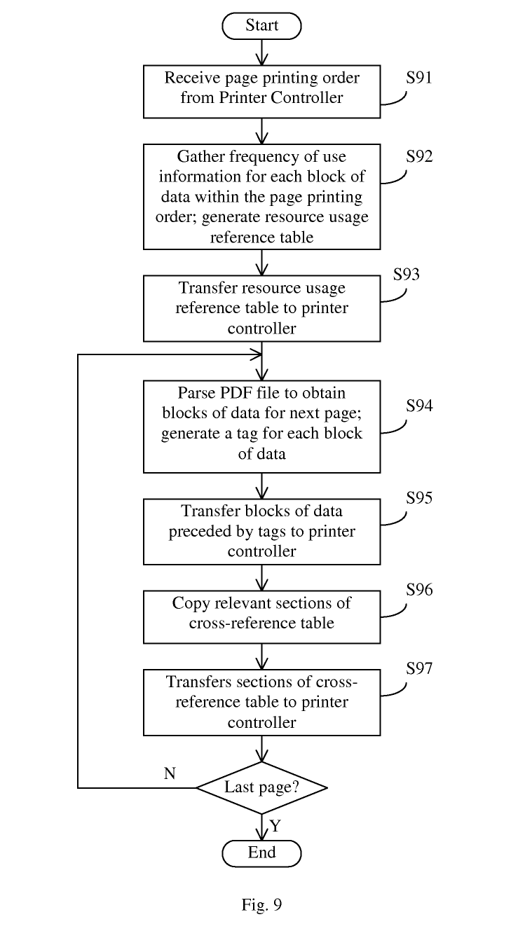

FIG. 9 illustrates a PDF data parsing and transferring process executed by the PDF parser 102 according to the fourth embodiment. As shown in FIG. 9, at the start of data transfer of a PDF direct print file, the parser 102 receives the page printing order from the printer controller (step S91). Based on the page printing order information, the parser iterates through the PDF file to determine which blocks of data are within the page printing order (i.e. to be transferred to the printer controller), gathers the frequency of use information for each such block of data, and generates a resource usage reference table (step S92). The resource usage reference table is transferred to the printer controller (step S93). The parser then parses the PDF file to obtain blocks of data for the next page according to the printing order, and generates a tag for each block of data (step S94). The tag includes a data type identification, size in bytes, and offset in bytes from the beginning of the file. The blocks are transferred to the printer controller, each block being preceded with an associated tag (step S95). For each block of data transferred, the parser also copies the section of the cross-reference table of the PDF file related to the block (step S96), and transfers the sections of the cross-reference table to the printer controller (step S97). For simplicity, steps S94/S95 and S96/S97 are shown in FIG. 9 in a sequential order, but the actual transfer sequence of the blocks of data and the related section of cross-reference table is not critical as long as each block of data and each section of the cross-reference table is preceded with a tag to indicate what follows. Steps S94 to S97 are repeated until all pages within the printing order are transferred.

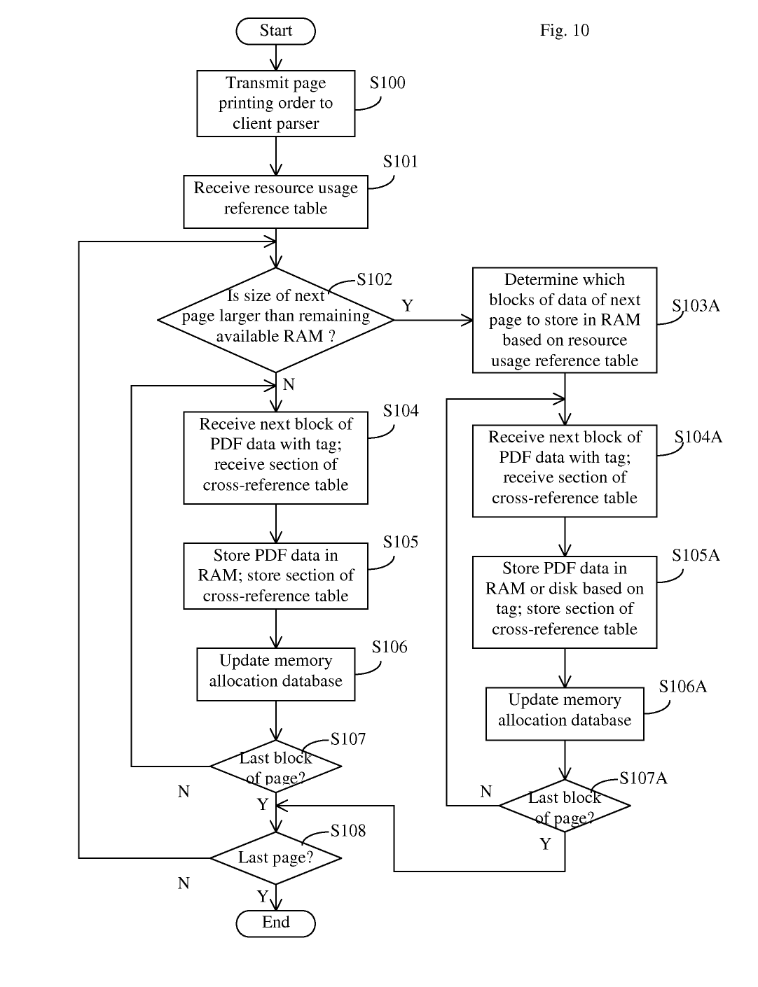

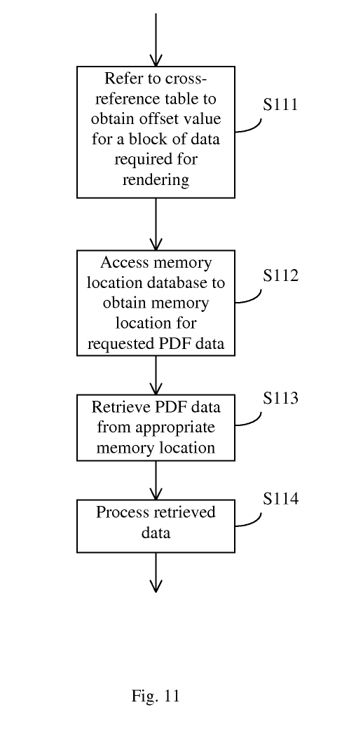

FIG. 10 illustrates a process executed by the preprocessor module 121 of the printer controller 120 for receiving and storing the PDF direct print data transferred from the client computer 100. This process implements a PDF data splitting algorithm. As shown in FIG. 10, at the beginning of the PDF direct printing process, the preprocessor module 121 transmits information regarding the page printing order to the parser 102 on the client computer (step S100). As described in connection with FIG. 9, with the printing order information, the parser transfers to the printer controller the resource usage reference table, followed by blocks of PDF data according to the page order together with tags, as well as sections of the cross-reference table relevant to the blocks of data. Thus, in step S101, the preprocessor module receives the resource usage reference table and stores it locally (preferably in the RAM) for use during data transfer and rendering. Based on information in the resource usage reference table, the preprocessor module determines whether the total data size for the next page in the printing order is larger than the size of the remaining available RAM (step S102). If not (“N” in step S102), then all blocks of data for that page will be stored in the RAM. Thus, the preprocessor module receives from the client computer the next block of PDF data with the associated tag as well as the relevant section of the cross-reference table (step S104). The block of PDF data is stored in the RAM, and the section of the cross-reference table is also stored (step S105). The tag associated with that PDF data can then be discarded. The preprocessor module updates the memory allocation database 123 to record where the block of PDF data is stored (step S106). Steps S104 to S106 are repeated until all blocks for that page of PDF data is received and stored (“Y” in step S107).

On the other hand, if in step S102 the preprocessor module determines that the size of the next page of PDF data is larger than the size of the remaining available RAM (“Y” in step S102), the preprocessor module examines the resource usage reference table to determine which blocks of data PDF for the next page will be stored in the RAM and which blocks will be stored on disk (step S103A). The preprocessor module receives from the client computer the next block of PDF data with the associated tag, as well as the relevant section of the cross-reference (step S104A). Based on the tag, the preprocessor module determines whether the block will be stored in the RAM or on the disk, and stores the data accordingly (step S105A). In step S105A, the preprocessor module also stores the section of the cross-reference table. The preprocessor module updates the memory allocation database 123 to record where the block of PDF data is stored (step S106A). Steps S104A to S107A are repeated until all blocks for that page of PDF data are received and stored (“Y” in step S107A).

Although not shown in FIG. 10 to avoid overcrowding, step S102 also determines whether the reserved RAM is full (i.e. no sufficient available space to store a block of data). If it is, then all subsequently received data will be stored on disk. The preprocessor module performs steps similar to steps S104 to S107 except the blocks of data are stored on disk rather than RAM.

The updating step S106 and S106A utilize the information contained in the tag for the block to update the memory allocation database. The memory allocation database 123 identifies each block of PDF data by its offset value in the original PDF file, and specifies the memory location (in RAM or disk) where the block of data is stored.

In steps S105 and S105A, the sections of the cross-reference table are stored either in the RAM or on the disk, preferably in the RAM as they will be referenced often during the rendering process. Preferably, all sections of the cross-reference table relevant to blocks of data within the printing order are stored together and form a new cross-reference table similar to the cross-reference table in the original PDF file except that it contains only sections that are relevant to blocks of data within the printing order. The memory location of the new cross-reference table may be recorded in the memory allocation database.

FIG. 11 illustrates a process executed by the rendering module 122 of the printer controller 120 for rendering a direct print PDF file. The blocks of data from the PDF file have been stored in the RAM and the disk, and a memory allocation database 123 has been established by the preprocessor module in the process shown in FIG. 10. A new cross-reference table has also been created as described above. The rendering process contain similar steps as conventional PDF rendering processes, such as converting the PDF data to PostScript (PS) data or other page description language (PDL) data, performing raster image processing (RIP) on the PS or PDL data to generate a bitmap image, etc. In a conventional rendering process, when a block of PDF data is needed for rendering, the rendering module refers to the cross-reference table to determine the location of the data within the PDF file. In the rendering process shown in FIG. 11, whenever the rendering module 122 needs a block of PDF data, either a resource or a command, it refers to the cross-reference table to obtain the offset value of the requested block of data (step S111). Then, the rendering module accesses the memory allocation database and, using the offset value which serves to identify the block of data, obtains the memory location of the block of data on the printer controller (step S112). The rendering module then retrieves the requested data from the appropriate memory location (step S113). The rendering module then processes the retrieved block of data to render a raster image (step S114).

The data transfer method described above may be used in a PDF direct printing process where rendering is performed concurrently with PDF data transfer from the client, or in a spooling process for spooling the PDF direct print job when the printer is busy printing another print job. The spooled file is stored on the printer to be printed when the printer becomes free. Spooling is advantageous because it frees the client computer so that it is not tied up to the printer when the printer is busy.

It will be apparent to those skilled in the art that various modification and variations can be made in the direct printing method and apparatus of the present invention without departing from the spirit or scope of the invention. Thus, it is intended that the present invention cover modifications and variations that come within the scope of the appended claims and their equivalents.

What is claimed is:

1. A method for transferring data of a file from a client computer to a printer controller connected to the client computer for direct printing, the file including a plurality of pages of data, the method comprising:
on the client computer,
(a) obtaining information regarding a page printing order, the information specifying which pages of the file are to be printed; and
(b) selectively transferring to the printer controller only pages of data within the page printing order.

2. The method of claim 1, wherein step (a) includes receiving the page printing order information from the printer controller.

3. The method of claim 1, wherein step (a) includes obtaining the page printing order information from a program on the client computer.

4. The method of claim 1, further comprising:
on the printer controller,
(c) obtaining the information regarding the page printing order;
(d) transmitting the information regarding the page printing order to the client computer;
(e) receiving pages of data from the client; and
(f) storing the received pages of data.

5. The method of claim 1, wherein step (b) comprises transferring to the printer controller pages of data in an order as the pages occur in the file.

6. The method of claim 1, wherein the page printing order information specifies an order in which the pages are to be printed, and wherein step (b) comprises transferring to the printer controller pages of data in the order specified by the page printing order information.

7. The method of claim 1, where each page of data in the file includes a plurality of blocks of data, wherein the page printing order information specifies an order in which the pages are to be printed, and wherein step (b) includes:
(b1) parsing the file according to the page printing order information to obtain a next block of data that will be processed next by a rendering process;
(b2) transferring the next block of data to the printer; and
(b3) repeating steps (b1) and (b2).

8. The method of claim 7, further comprising:
on the printer controller,
(c) transmitting information regarding a page printing order to the client computer;
(d) receiving blocks of data from the client computer;
(e) storing the received blocks of data in a memory; and
(f) recording in a memory allocation database memory locations where the blocks of data are stored.

9. The method of claim 1, wherein step (b) includes:
(b1) examining the file to generate metadata indicative of contents of blocks of data to be transferred according to the page printing order information; and
(b2) transferring to the printer controller blocks of data with associated metadata according to the page printing order information.

10. The method of claim 9, wherein the printer controller has a first, random-access memory (RAM) and a second memory, the method further including:
on the printer controller,
(c) transmitting information regarding a page printing order to the client computer;
(d) receiving blocks of data with associated metadata from the client;
(e) based on the associated metadata, storing each block of data either in the RAM or in the second memory; and
(f) recording in a memory allocation database memory locations where each block is stored.

11. The method of claim 1, wherein the file is a PDF (Portable Document Format) file.

12. A computer program product comprising a computer usable medium having a computer readable code embodied therein for controlling a data processing system including a client computer and a printer controller connected thereto, the computer readable program code comprising code configured to cause the client computer to execute a client process for transferring data of a file from the client computer to the printer controller for direct printing, the file including a plurality of pages of data, the client process comprising the steps of:
(a) obtaining information regarding a page printing order, the information indicating pages of the file to be printed; and
(b) selectively transferring to the printer controller only pages of data within the page printing order.

13. The computer program product of claim 12, wherein step (a) includes receiving the page printing order information from the printer controller.

14. The computer program product of claim 12, wherein step (a) includes obtaining the page printing order information from a program on the client computer.

15. The computer program product of claim 12, wherein step (b) comprises transferring to the printer controller pages of data in an order as the pages occur in the file.

16. The computer program product of claim 12, wherein the page printing order information specifies an order in which the pages are to be printed, and wherein step (b) comprises transferring to the printer controller pages of data in the order specified by the page printing order information.

17. The computer program product of claim 12, where each page of data in the file includes a plurality of blocks of data, wherein step (b) includes:
(b1) parsing the file according to the page printing order information to obtain a next block of data that will be processed next by a rendering process;
(b2) transferring the next block of data to the printer; and
(b3) repeating steps (b1) and (b2).

18. The computer program product of claim 12, wherein step (b) includes:
(b1) examining the file to generate metadata indicative of contents of blocks of data to be transferred according to the page printing order information; and
(b2) transferring to the printer controller blocks of data with associated metadata according to the page printing order information.

19. The computer program product of claim 12, wherein the file is a PDF (Portable Document Format) file.
